(19) United States
(12) Patent Application Publication
(10) Pub. No.: US 2003/0158897 A1
(43) Pub. Date: Aug. 21, 2003

(54) Networked platform for creating and supporting communities

(75) Inventors: Ron Ben-Natan, Modi'in (IL); Chava Kahana, Jerusalem (IL); Miri Levy, Jerusalem (IL); Rosa Miroshnikov, Jerusalem (IL); Oded Sofer, Kiriat Gat (IL); Lea Zafransky, Jerusalem (IL)

Correspondence Address: G.E. EHRLICH (1995) LTD., c/o ANTHONY CASTORINA, SUITE 207, 2001 JEFFERSON DAVIS HIGHWAY, ARLINGTON, VA, 22202, US

(73) Assignee: ViryaNet Ltd.

(21) Appl. No.: 09/725,848

(22) Filed: Nov. 30, 2000

Related U.S. Application Data
(60) Provisional application No. 60/203,081, filed on May 9, 2000.

(51) Int. Cl. G06F 15/16

(52) U.S. Cl. 709/204

(57) ABSTRACT

A system for defining communities and matching users into said communities, said matched users thereby gaining access to one or more elements associated with said communities; the system comprising a host connected to a network being for communication with a plurality of users, said host being configured for: creating at least one community by defining attributes for each of said communities; and defining one or more elements associated with each of said communities; and assigning attributes to a user, said attributes extracted from information associated with the user; and matching said attributes of at least one user to attributes of at least one community; assigning said user to said community based on the result of said matching; said user thereby gaining access to at least one element associated with said community.

### RELATIONSHIP TO EXISTING APPLICATIONS

This is a continuation-in-part of U.S. Provisional Patent Application No. 60/203,081 filed May 9, 2000.

### FIELD OF THE INVENTION

The present invention relates to a networked platform for creating and supporting communities and, more particularly, but not exclusively to using Internet or Intranet systems as the platform for creating and managing the communities.

### BACKGROUND OF THE INVENTION

The Webster dictionary's definition for a community is “a unified body of individuals” or “a group of people with a common characteristic or interest, living together within a larger society.” A community in the classic sense is a categorization or a taxonomy of individuals that have common interests (whether passive or active). This commonality creates the fabric that is the essence of the community.

Mankind is inherently social. All activities performed by us are performed within a certain social context. The social context in which mankind functions is a community. A community may be one's family, one's coworkers, one's reading group, etc. Each such community has a set of defining attributes. For example, the community of all lawyers is the set of people that have studied law and have successfully taken a qualifying examination. The set of all New Jersey lawyers is a smaller set and includes all lawyers that are certified to practice in New Jersey.

People converge within communities for a reason. A community aggregates people with higher levels of commonality than is typical (by the very categorization notion—people in the community have many common interests). People with such high levels of common interests often are interested in the same type of information and want to do similar things.

Since in the last decade various electronic communication forms have become so wide spread that people no longer need to have any direct personal contact in order to converge on the basis of common interest, communities are actually created in the “virtual space”.

Since the Internet is a platform providing ubiquitous access, it has been from the outset a platform which uses collaboration tools and other such communication methods to provide—by the very nature of its connectivity—a kind of “living together” aspect of the forming of community. This is the sense by which “community” has been interpreted vis-a-vis the Internet. We are all familiar with chat rooms and with chat software. Such tools allow ad-hoc communities to be formed by defining chat rooms or interest groups based usually on a single word or phrase and then allowing people to use the Internet in order to converse with anyone else in this chat room. This approach is based on setting up sites and allowing people to join such interactive sessions. In such a scheme the person is allowed to join a group of people, or a community, simply by the fact that they wish to join. However, apart from the fact that these people can converse on-line there is little to support the community aspect—e.g. there are no applications associated with the group, no information targeting this groups, etc. In fact, while this kind of feature has been defined in the trade press as community-enabling tools it does not address the crux of what a community truly is and how the existence of communities benefit mankind. It does very little in order to create the very fabric of the community. In fact, while such collaboration software is in use in the home it is not being viewed as the all-important part of the business community. One reason may be the fact that a business community is a rich construct and its fabric needs to be a rich combination of data and applications. In addition this kind of ad-hoc communication lacks on aspect of perseverance of a real community.

Another example of community activity on the Internet that is very well known is that of news groups and forums. News groups are available on almost any topic in the world in public forums and in private contexts. By participating in news groups one can read what others have to say on a particular topic and post new messages. Newsgroups create a sense of community because people belonging to a newsgroup have a common interest that forms the commonality by which this particular community can be defined. Additional examples of such categorization include on-line forums, list servers, etc. These solutions make use of the Internet in order to provide a mechanism for publishing information in a targeted manner based on some categorization. This categorization is usually based on a single attribute. For example, joining a newsgroup called comp.lang.java means that one is interested in the Java programming language. This class of solutions includes publish/subscribe methods in which an individual can subscribe to a certain interest and when anyone publishes something that belongs to this category the individual is sent the recently published post. These solutions provide one-dimensional categorizations through which information may be distributed. However, they again fail to capture the elements that are required in order to support a community and do not provide a basis for which the community as an entity can be used to support the individuals belonging to this community.

The Internet is full of Web sites that cater to a certain community. Sites exist for people interested in a certain stock market, people interested in certain sports, etc. The number of sites that target a certain community is staggering. However, these sites are pre-built for a certain audience and therefore are not a platform that allow the creation and dynamic management of a plurality of online communities—they simply aggregate information (and sometimes applications) used by a certain community. An individual interested in specific information needs to actively search and sort out through a large amount of information time and time again.

Another aspect of community management on the Internet has involved categorization. Content is often categorized in a way that makes it simple for individuals to find the right information or applications and use them. Categorization of information is done based on some predetermined definitions of groups. This is a “pull” model by which a site aggregates information., content, and applications and individuals access these by virtue of having access to the site. Mostly, all categories are open to all individuals but occasionally a small set of categories is created (typically three to ten) and different individuals are provided access to one of these limited sets of entry points. Access permissions are usually defined per user. This second aspect of community creation—that which is based on categorization—has received much attention lately with the mainstream acceptance of the importance of business communities. The approach taken by all such vertical portals and electronic market places has been to define a limited number of categories and for each such category define content. Users are associated with these categories and this defines the association of users as members of various communities supported by the Internet portal. However since this association is done per user it is difficult to support the huge amount of users daily seeking the advantages of the Internet, and moreover to reassociate users to communities whenever the user information is changed or updated or when the communities'categories or attributes change.

Converging into communities is usually not a random process that is initiated by individuals. Communities are created in a proactive manner by someone (people or other organizational entities) that want to make use of such a community in order to deliver something in a more efficient way. These are often known as the organizers of the community. For example a community may be created precisely for the sake that certain information will reach the right targeted audience and thus lessen waste that would occur if random distribution were attempted. Such communities are also created in order to provide access to operations and not only information. In addition, access levels are usually also associated with community groups and sometimes the main purpose of defining a community is as an entity with which access level can be associated. For example, companies make employee badges that have different access levels depending on the community the employee belongs to (e.g. manager, security guard, Jab operator, . . . ) and on-line banking provides different types of transactional capabilities depending on whether the customer is a preferred customer, regular customer, or a customer of the private-banking group.

There is thus a widely recognized need for, and it would be highly advantageous to have, a system for the creation and management of communities devoid of the above limitation.

### SUMMARY OF THE INVENTION

According to one aspect of the present invention there is provided a system for defining communities and matching users into those communities, the matched users thereby gaining access to one or more elements associated with the communities. the system comprises a host that is connected to a network that serves for communication with a plurality of users, the host is configured for: (a) creating a community or a plurality thereof by defining attributes for each of the communities, (b) defining one or more elements associated with each of the communities, (c) assigning attributes to a user. The attributes are extracted from information received from input from any combination of the user itself, a remote database, a local database, a local system, a remote system, a web site, a custom-built algorithm and (d) matching the attributes of at least one user to attributes of at least one community. Assigning the user to the community is based on results of matching. Through this process, the user preferably gains access to at least one element associated with said community.

According to further features in preferred embodiments of the invention described below, the information associated with the user is received from input from any one of a group comprising the user itself, a remote database, a local database, a local system, a remote system, a web site, a custom-built algorithm, and any combination thereof.

According to still further features in the described preferred embodiments, the community attributes are inferred based on data available to the host or based on data that is associated with users.

According to yet further features in the described preferred embodiments, the host is configured to rematch the attributes of users to attributes of communities automatically whenever there is an occurrence of any one of a group of conditions comprising a change in at least one attribute of at least one community, an update of at least one value of an attribute of at least one community, a change in at least one attribute of a user, an update of at least one value of an attribute of a user or any combination thereof.

According to still further features in the described preferred embodiments, the hosts are configured such that the elements are associated to a community at the community's set up time.

According to yet another feature in the described preferred embodiments, the access of the user to at least one element or to a subset of elements is according to a permission level being assigned, to the user. The permission level may be determinable at setup time of at least one community for at least one user according to anticipated user attributes.

According to still another feature in the described preferred embodiments, an element may be customizable for the user based on one or more of the user's attributes. The element may be customizable once per community, at set up time according to foreseeable user attributes.

According to yet another feature in the described preferred embodiments, elements associated with at least one community may be parametric. The parametric element is able to receive a value that is specific to a user that is matched to at least one community, as an argument. The value is derived from any one of a group comprising a computation, an algorithm, a simple value of a user attribute, a simple mathematical value and any combination thereof that are based on any information available to the host.

According to another aspect of the present invention there is provided, a system comprising a host that is connected to a network. The host is configured for a process by which data elements that describe an entity and are presented in the form of a directed graph, along with data that is stored in a database are coupled together in order to generate a third data structure. The third data structure is then used to identify any of a URL link, an information document, a text document, a value, an application, and an access to an application.

According to yet another aspect of the present invention there is provided, a method of producing compatibility between different forms where a first form is preferably programmed in any hierarchical format, including forms composed of tagged fields. The method comprises the steps of: (a) setting up a hierarchy of labels as nodes on a tree such that each node is specifiable by a descending order of labels, (b) tagging node data with labels of a node if an appropriate node exists, and (c) adding a new node to the tree if an appropriate node does not exist, and (d) tagging field data in the second form with a concatenation of labels that match the traversal on the tree compatible with the first form. The first form may be an instance of the extensible markup language (XML), and the second form in HTML or any extension of it such as DHTML or XHTML.

According to still another aspect of the present invention there is provided, a method for use on a system comprising a host and a network. The system has at least one community defined by at least one attribute and the community has at least one element. The method is for selecting at least one attribute of a community, that is parametric and receiving the value of an attribute belonging to a user already matched to the community. The value defines the access gained by the user to at least one element.

According to an additional aspect of the present invention there is provided, a method of dynamically matching a plurality of users to at least one user group, at a host that is connected via a network to the users, the method comprises the steps of: predefining at least one user group in terms of a value of at least one attribute, assigning at least one attribute to at least one user, obtaining a value for the user attribute, matching the user attribute value to the group attribute value, and assigning the user to the group based on a result of the matching.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 shows block diagram illustrating the system of an embodiment of the present invention;

FIG. 2 shows a block diagram illustrating the matching of at least one user to at least one community,

FIG. 3 shows a flow chart diagram illustrating preferred steps of a method of creating a community and defining it's attributes and elements;

FIG. 4 shows a flow chart diagram illustrating preferred steps of a method of matching a user with a community;

FIG. 5 shows an example of files containing user information and a method of using these files to attach a value to a parametric element;

FIG. 6 shows an example of a process by which data describing a user (in this case an XML structure) and an XSL structure are combined and used to read data from a database (in this case by creating an SQL statement);

FIG. 7 shows a registration form; and

FIG. 8 shows the coding of the top part of the form of FIG. 7 according to a preferred embodiment of the present invention, thus serving to illustrate how the form may be coded to simplify indexing of the data provided to the form by means of labeling of HTML form elements so as to create and match XML structures.

### DESCRIPTION OF THE PREFERRED EMBODIMENTS

The embodiments described below provide a system for creating, managing and supporting communities which can be used for bringing users together on the basis of their common attributes and interests into multidimensional communities which support their users in an on going manner by supplying them with a variety of information documents, access to applications, contacts, tools for analyzing and processing information etc. according to their needs.

Specifically, this embodiment can use the Internet or an Intranet for the definition and management of Internet or Intranet communities. The possibility of using any element that can be delivered to a user over the Internet to construct and define communities leads to wide freedom in forming the fabric of online communities.

The present embodiments may be used to form business communities. In order for a business community to function correctly, each community member typically requires access to a subset of applications and services. In addition, even when a service, application, or information element is provided to a community member there may be attributes that affect how this is accessed or what exactly is provided.

The principles and operation of a system for creating, managing and supporting communities according to the present invention may be better understood with reference to the drawings and accompanying descriptions.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

For purposes of this specification and the accompanying claims the term “community” refers to a declaration of a group defined by at least one attribute and expected to be joined by at least one user, for the purpose of supplying that user with access to at least one element associated with the community.

For purposes of this specification and the accompanying claims the term “user” refers to a user connection to the network. A real world individual may log on to the network as several users, and conversely, several individuals may log on as a single user.

For purposes of this specification and the accompanying claims the term “attribute” refers to any property, description, trait, quality, name etc. that may be used to describe a user or an individual or a group. An attribute may have a calculated value that results from any computation, procedure or algorithm.

For purposes of this specification and the accompanying claims the term “host” refers to any computer, computer platform, or set of computers that may be configured to run a program, such as: a server, a web server, a web site, an Intranet server, a distributed or parallel computer, a network or collaborative computers, a main frame computer, or any combination of the above.

For purposes of this specification and the accompanying claims the term “network” refers to any infrastructure or means of data transfer including but not limited to, telephone connections, cellular telephone connections, the Internet an infrared frequency transmission, a local area network, an Intranet, a wide area network, a metropolitan area network, and a radio frequency connection, including infra-red and microwave links.

For purposes of this specification and the accompanying claims the term “element” refers to anything that is of use to a user's environment as a member of a community. This can include, but is not limited to, URL links to other sites, URL links to applications, content placed on some site or repository, information that is a result of a query of some database, (This type of element can include information that is relevant to the user's function as a member of the community—for example, all members of the management community in a large organization will be interested in the company's revenue outlook which can be retrieved from the finance database.), information that is the result of a query performed as an HTTP request on the Web (regardless of whether it is a GET or a POST request), information that is the result of any such query or access using other protocols such as IIOP, Gopher, FTP, SMTP, TCP/IP, SQLNET, etc. Information that is a result of some computation, reports that need to be provided to members of a certain business community, information commonly termed as “business intelligence” or “key performance indicators”, information that is a focused summary of a lot of raw data to the form that is meaningful in a business sense, documents placed in a document manager or document repository, access to an external application be it local or on a remote server, and the activation of a procedure. The latter is a generic element. Sometimes in order to be a member of a community a certain process needs to be followed (for example registration with another site or the creation of a new user in another application). This type of element serves to invoke such a procedure when indeed an individual is determined to be a part of this community. A typical example is one in which it is identified that a user belongs to a community that should have access to an external application. In this case it is not enough to provide a link to the external application but also a creation process needs to be initiated in which a user is created in the external application and the username in the external application is associated with the user environment.

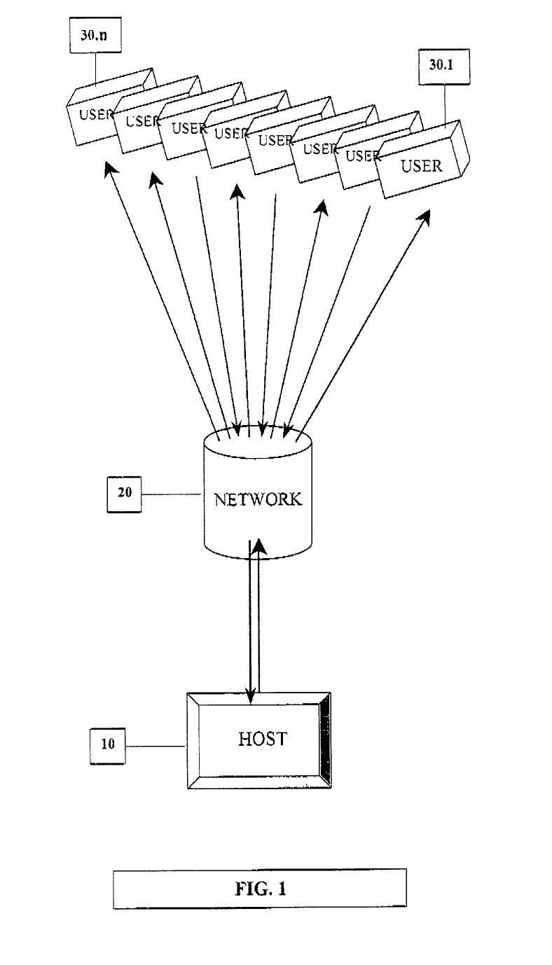

Referring now to the drawings, FIG. 1 is a generalized diagram illustrating a system for creating, managing and supporting communities and matching users to these communities.

As shown in FIG. 1, the system comprises a host 10 connected to a network 20. Network 20 serves for communication between a plurality of users 30.1-30.n and host 10. Host 10 of the system of FIG. 1 is configured to carry out the following functions:

1. Defining community groups through sets of defining attributes and associating Internet elements with the community groups. Each such community group includes sets of information and application elements that define what users belonging to the community have access to, what information they can see, how they see it, etc.

2. Identifying users in terms of their defining attributes and using these defining attributes to categorize them into the community groups to which they belong.

3. Once these associations have been performed, the elements defined for these communities are available to users 30.1-30.n. The elements may be customized and personalized for the user based on attributes that are specific to the user within the community.

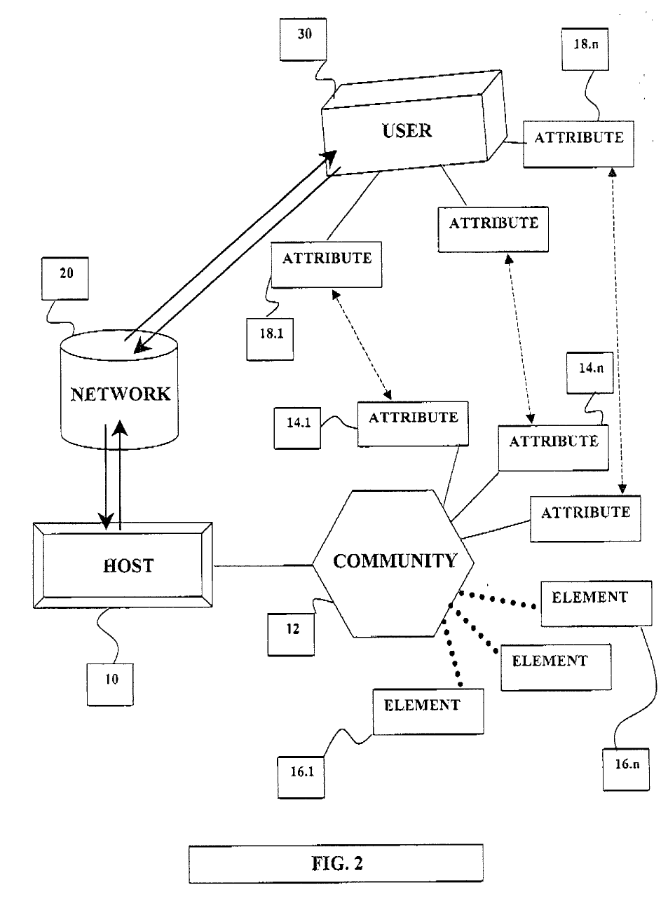

FIG. 2 is a simplified block diagram illustrating the matching of at least one user to at least one community in a more detailed fashion. FIG. 2 depicts host 10 connected to network 20 and user 30 that connects with host 10 via network 20. FIG. 2 further details at least one community 12 that is defined on host 10. Also illustrated are attributes 14.1-14.n and elements 16.1-16.n which are preferably defined for community 12 at set up time. Attributes 14.1-14.n (or at least one of them) define the community and its boundaries in terms of the specific users that can belong to that community, i.e. a user 30 has to comply with at least one of attributes 14.1-14.n. Elements 16.1-16.n represent the element that will be added to user 30's environment, once user 30 is assigned or found to belong to community 12. The elements are essentially the added value that a user gets from belonging to a community, as they preferably supply the user's ongoing information needs. In addition attributes 18.1-18.n are defined for user 30. Values are attached to attributes 18.1-18.n after processing user 30's information. These values are checked to see if they comply with the demands that are defined for attributes 16.1-16.n (i.e. the matching process). If they do comply, completely or partially, according to community 12's definitions, then user 30 is matched to community 12 (i.e. becomes a member of the community) thereby gaining access to elements 16.1-16.n. Further details of the embodiment described in FIG. 2 will be explained hereinbelow.

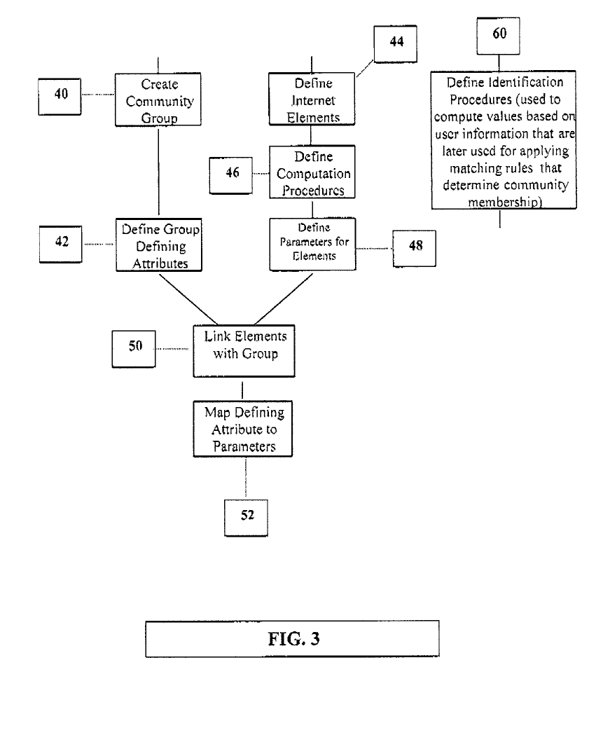

FIG. 3 is a simplified flow diagram depicting the setup/definition processes of a community at an overview level. As can be seen by the figure, the setup process according to an embodiment of this invention involves three types of definitions: definition of groups and their defining attributes, definition of (possibly parametric) elements and computational procedure (for computing values used as arguments for the parameters in the elements), and identification procedures. The first and second setup/definition processes merge in that elements are associated with groups.

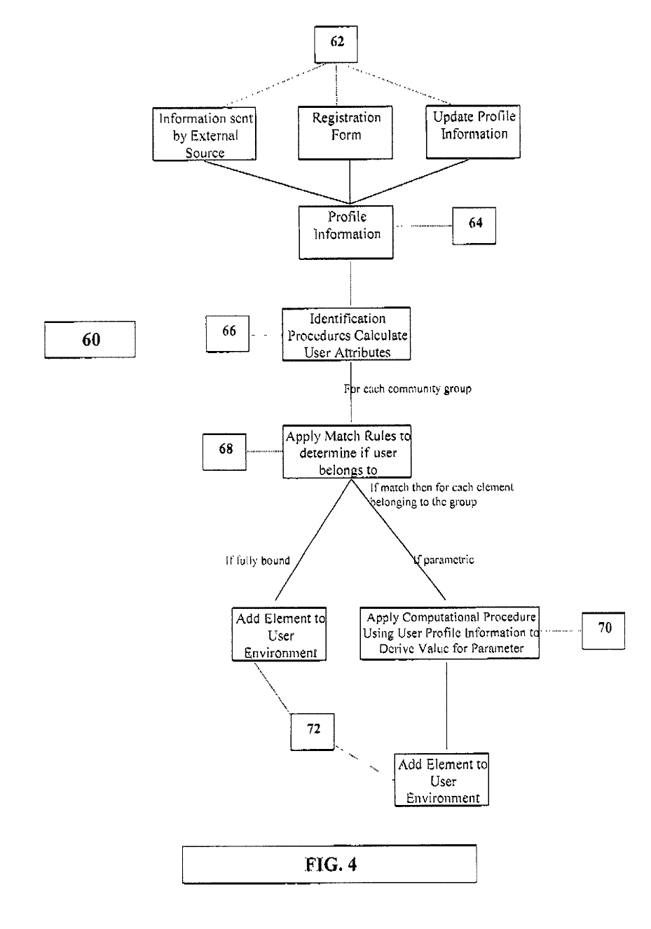

Further detailing on FIG. 3 each block represents a step in the definition of a community, which steps are: creating a community 40 (e.g. a start up process that may contain steps such as naming the community), defining the attributes that define the community 42 (e.g. the values of attributes assigned to users will define the community membership), defining elements that are attached to the community 44 (e.g. the elements that are attached to member's user environment), defining computation procedures that are needed to bind values to attributes or elements, in order to implement the matching process and attach members to the community 46, defining which elements are parametric, i.e. gain their value according to the specific member 48 (this process will be further explained in greater detail hereinbelow), linking the elements to the community groups 50, defining community attributes that are parametric and obtain their values from the specific user 52. Parametric attributes preferably allow for different members of the same community to gain different access levels to the community's elements or to gain access to different elements all together. Block 60 refers to the process of defining which user belongs to a community, and will be further detailed below with reference to FIG. 4. Further details about the process that is depicted in FIG. 3 will be described with reference thereto.

According to the embodiment of FIG. 3, each community is associated with elements. This association may be performed at setup time and provides the basis for defining what forms any given community. It is preferably done once per community and is not dependent on the number of members the community may eventually have.

Users are preferably associated with one or more communities. For example, a user that belongs to three communities preferably gets access to all elements of each one of the three communities.

Matching a user with a certain community can be done manually by an administrator but is preferably done using a set of identification procedures and matching rules. Matching rules are associated with communities and define what is required for a user to be a member of a given group or community. The rules preferably make use of information collected about the user (e.g. in the registration process) by activating the identification procedures, information maintained within company databases, or information readily available on the Internet—all these together providing a rich base for defining community-inclusion. The phase in which user attributes are computed is referred to as a user identification phase. By collecting information about the user and correlating it with information in other sources (such as databases) it is possible to more correctly categorize the user into the appropriate communities. Such a stage is referred to as “attribute matching” and is based on applying sets of matching rules. The outcome of the attribute matching phase is a definition of which communities a user belongs to.

The process of evaluating which rules are satisfied (and thus which communities a user belongs to) is performed whenever the rules change or when information about the user is updated. This means that community association dynamically changes when the user's profile or other such data is changed. Thus, the present embodiment preferably supports the possibility that a user may change his profile and in the process, be categorized differently. For example, a person relocating to a different country may now be associated with a different set of geographical communities. Since this process is dynamic and is invoked whenever such profile changes occur, the communities to which the user belongs are always preferably kept up to date in respect of changing circumstances.

Elements used in community definition may be parametric. Information or application elements that are associated with the community may also include parameter-based data. When a set of rules is evaluated and a certain user is provided access to a certain community, elements of the community are preferably added to the user's environment. If such an element is defined to be parametric, a value may then be computed for the user joining the community. This value can be based on any computation or algorithm and can permit the user to access information sources such as corporate databases and the Internet or parts of the Internet or all or parts of an Intranet. This value is thus used as an argument to the parametric element. Eventually, when the element is associated with the user, it is fully bound.

Once setup has been performed and the community groups (along with their elements) have been defined, users may be associated with community groups. This association can either be done manually or automatically.

Each community preferably has a set of attributes. These attributes form the basis by which community membership is defined. By applying matching algorithms such attributes are used to decide whether or not a user should belong to the community.

A manual process is one in which a system administrator manually makes an association between a user and a community group (i.e. defines the user to be a member of the community). The user information is then used in the normal way to compute a set of values as required for each of the elements associated with any of the community groups that the user is being associated with. It will be appreciated that, in the manual process there is no automatic identification phase and no automatic matching phase since the administrator decides which groups a user belongs to, and the phase that remains for automatic computation is the computational phase and the creation of the user environment.

FIG. 4 is a generalized diagram which provides a high level overview of an automated process for matching a user to one or more communities and adding elements that are associated with the communities, to the user's environment, according to a preferred embodiment of the present invention.

Each block in FIG. 4 represents part of the process of automatically matching at least one user to at least one community. A first stage of gathering information about the user from various sources is indicated by numeral 62. Block 64 refers to a step of creating a user profile that is derived from the various information sources 62, Creating identification procedures that calculate values for the user attributes is indicated by block 66. Block 66 is followed by a stage 68 of applying matching rules for each community to determine whether a given user belongs to a respective community (or communities) (typically this would include comparing user attributes to community attributes). If the user is found to match a community then the process goes on to add elements that are associated with the community to the user's environment, either directly 72, or after applying computational procedures to determine values for parametric elements 70 (such a value may determine, for example, the content of information relayed to the user via the element or the access level of the user to an element etc.).

In the automated process, a user either fills in a registration form, or information about the user is otherwise obtained (for example from a database or an external system). The information is incorporated to provide a user's registration profile and later may be used for updating processes (so that when a user updates his profile information the community management processes are reapplied and community membership may be updated).

The information describing the user is preferably used by the identification procedures. These procedures use the user information and may additionally make use of information stored in corporate databases or information available on the Internet in order to identify the user and compute a set of attributes that are later used for categorization. Attributes thus provided are matched with the attributes defined for the communities and the matching rules then preferably define which communities the user may belong to.

Once the process identifies that a user may belong to a certain community it looks at all elements associated with the community. Each such element that is not parametric preferably becomes part of the user's environment (since the user is now declared to be a part of the community). An element that is parametric needs to be fully bound. For example, if an element has COUNTRY as a parameter then the user's country value is preferably used as an argument for the country parameter in order for the element to be part of the user's environment. The computation procedures are defined per the element. The user information is passed as input to the computational procedure. The end result is a value that is used to fully bind the element and make it part of the user's environment.

Attributes

Community attributes do not necessarily need to have a singular form. In the simplest case a community attribute can simply be a name-value pair (e.g. a two-tuple of strings) in which the first element (string) is the name of the attribute and the second element (string) is the value. However, attributes can be as complex and as generic or as specific as desired (e.g. being computed values or even algorithms themselves). The system uses these attributes when it applies the matching rules. As long as the attributes and the rules are related to one another in a way that the matching rules applied on the attributes can produce a TRUE or FALSE answer—the matching rules can be applied. TRUE means that the user belongs to the community and FALSE means that the user does not belong to the community.

In the following simple example, suppose that we want to define two simple communities: one community consisting of all males and one community consisting of all females. Two communities are preferably defined and for each of these communities an attribute will be defined by the name of GENDER. The attribute in one group will have a value of female or “F” for the GENDER attribute and the attribute in the second group will have a value of male or “M” for the GENDER attribute. The user information in such an example should be such that it is possible to compute per user whether the user is a male or a female. Once this identification procedure is performed a simple matching rule defines that any user who can be identified as a female will become a member of the community with the attribute value of “F”.

Elements and Parametric Elements

The system of the present embodiment may implement elements in a sequence of steps. Each step may comprise either access to an Internet resource or alternatively, a procedure that needs to be activated. The embodiment allows construction of these sequences of steps at setup time. By implementing elements in the above manner it can implement any element (with any combination of access and invocation).

The present embodiment preferably has an additional capability as a consequence of the ability of the elements to be parametric. This means that an element definition (e.g. a URL or an invocation of a procedure) may be defined using named parameters. For example, assume we would like to provide a user with access to weather based on address information (and zip code) that the system has as part of the user information. The system adds a URL link as an element to the ALL_USERS community. The element can have the form of:

http://infoseek.go.com/Centers/Weather?tid=16377&sv=IS&lk=noframe s&query={ZIP_{—CODE}&x=}41&y=11

where {ZIP_CODE} is a parameter. Later, when the element becomes a part of the user's environment, a value will replace the parameter and the link that is part of the user's environment will actually resemble:

http://infoseek.go.com/Centers/Weather?tid=16377&sv=IS&lk=noframe s&query=07047&x=41&y=11

There are substantially no limitations on possible parameters and the elements to which they may be applied. Every element may have zero, one or more parameters and there may be more than one element using the same parameter.

Once elements are defined they are linked to communities. Communities can contain any number of elements and elements can belong to any number of communities.

User Information and Defining Identification Procedures

Identification procedures may help in building attribute sets that describe a user based on user information that is collected by the system. Such user information may include any data structure(s) that is collected by the system about the user. This includes information that the user fills in during the registration process (by filling in registration forms as described in the next section). information that is already in the system from previous user engagements or information about the user that is received from other applications, sites, databases or systems. All of this information together is called the “user information”.

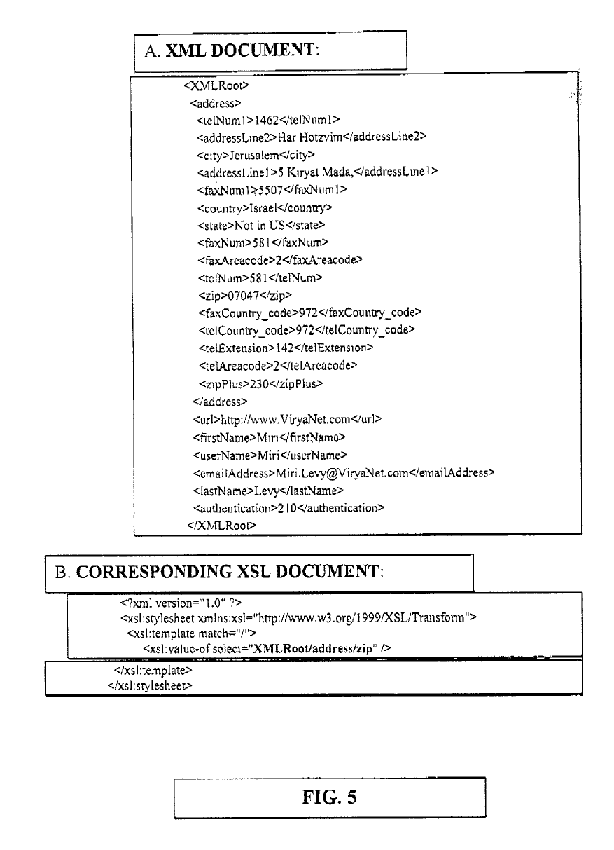

The user information may be maintained in any form. This does not affect the process or algorithms. Preferably, however, the user information is capable of representation in the form of a directed graph (the nodes being the data elements and the edges being pointers). More often than not the user information has a hierarchical structure and in such cases one choice is to store the user information as an XML document. An example of such a document is shown in FIG. 5A.

User information provides input to the identification procedures. The output of such a procedure is a set of attributes that preferably have the same form as the attributes used to mark communities. The reason for using the same form is that the matching algorithms take in a set of attributes that mark the community and a set of attributes that are associated with the user and apply the matching algorithm. For example, if the implementation of the community attributes are name-value pairs (both being strings), then the system will use the same format for attributes that are created by the identification procedures.

The identification procedures themselves may take a number of forms, and the embodiment may implement a number of identification procedure types. Depending on the structure of the attributes, an identification procedure may be categorized either as a primitive procedure or as a compound procedure. A primitive procedure is one that has a name and produces a value when activated. Compound procedures are composed of any number of primitive procedures and often make use of compound data structures, thereby preferably comprising a definition of how to form a compound data structure by adding together names and values created by the primitive procedures.

In most cases name-value pairs are sufficient for attributes associated with communities and users. In this case the system only requires primitive identification procedures. Examples of types of individual procedures are:

1 Value extracted from the user information

2 Value extracted from a combination of a database and the user information

3 Value extracted from a combination of a Web site and the user information

4 Value extracted from any custom-built algorithm and the user information

The above types of individual procedures are described in greater detail below.

Compound procedures preferably begin with a specification of a data structure (in this case XML can be used to describe the structure but any other representation of a directed graph is equivalent) along with a mapping of where, in the data structure, to place the values defined by the primitive identification procedures. For example, if an XML structure is used then the elements in the XML document will be a mix of fixed elements and elements created from primitive identification procedures. The elements created from primitive identification procedures preferably have a tag that is the name of the attribute computed by the primitive identification procedure. Such an XML element preferably includes a sub element that is derived from the value computed when applying the primitive identification procedure. The data type is preferably maintained as an attribute of the XML element. If, in using such elements, a generic representation of a graph is used, then the nodes preferably take the values of the primitive identification procedures and the edges are tagged with the names of the primitive identification procedures.

The different types of primitive identification procedures include the following: The simplest identification procedure extracts a data item from the user information and uses that data item as the value associated with the user for the purposes of the present identification procedure. The identification procedure has a structure that allows it to reference information within the user information; the actual representation varying with the actual representation of the user information. If for example the user information is represented as XML (as described and exemplified earlier) then an XSL document may be used, using XPATH elements in order to define where the information the system is interested in resides. By using XSL the system can also apply simple computational elements on combinations of such values. For example, given the XML user information shown in FIG. 5A, if the value that is required is the zip code extracted from the user information then the identification procedure will be based on the XSL document shown in FIG. 5B.

Wile identification procedures for values in the user information are very useful (the user information typically includes a lot of information that is important to building community membership), this is often not enough. The main deficiency of such identification procedures is that in order to fully identify a user and know to which communities that user belongs, it is not enough to get information from the user. It is often necessary to cross check the information with data that is stored in various databases. Two typical cases may be defined. The first is one in which the decision regarding community membership cannot be inferred from an answer provided by the user. The second case is one in which security policies require that users provide data through which they can be authenticated (and the authentication information itself is maintained in a database or other repository).

An example of the first case may be a user registering a serial number of newly purchase equipment. Based on information maintained in the database regarding sales orders (which include serial numbers), the user can be categorized with a city and/or state in which the equipment was purchased. This can be used to associate the user with the local service center where the equipment can be serviced.

An example of the second case is one in which the site includes secure information and access is forbidden except to authorized users. For example, suppose there is a community of “board members”. Users belonging to the “board members” community are assigned access to all of the company's financial information, HR information, etc. It is however, not the type of information that all users should have access to. Thus, before associating a given user with the community of board members, user authentication is required. There are many ways that authentication can be performed and the platform of the present embodiment supports many such methods. Ultimately, whatever the authentication method may be, it generally involves comparing information retrieved from the user (e.g. password, authentication code, smart card ID, telemetric information, etc.,) with information stored in the database. Comparison of data received with data stored is preferably handled by identification procedures that have access to databases. The result is an attribute value “authenticated” or “identified” or “authorized” that is based on comparison of the user input with user information or information stored in the database.

An assumption with such identification procedures is that a lookup process needs to be performed. A lookup process involves looking up data from the user information and/or looking up data stored in the database. Any combination of such activities (in any order and any sequence) is possible. Such combinations provide very complete patterns by which attributes can be associated with the user.

When user information is stored as an XML structure and the data repositories are relational databases, the following method may be used for implementing identification procedures. The method is applicable not only to the task at hand but also to any task that requires a process by which data describing an entity and data that is stored in a relational database need be coupled together in order to generate other data structures.

In order to access information from a relational database an SQL for querying the database is preferably constructed.

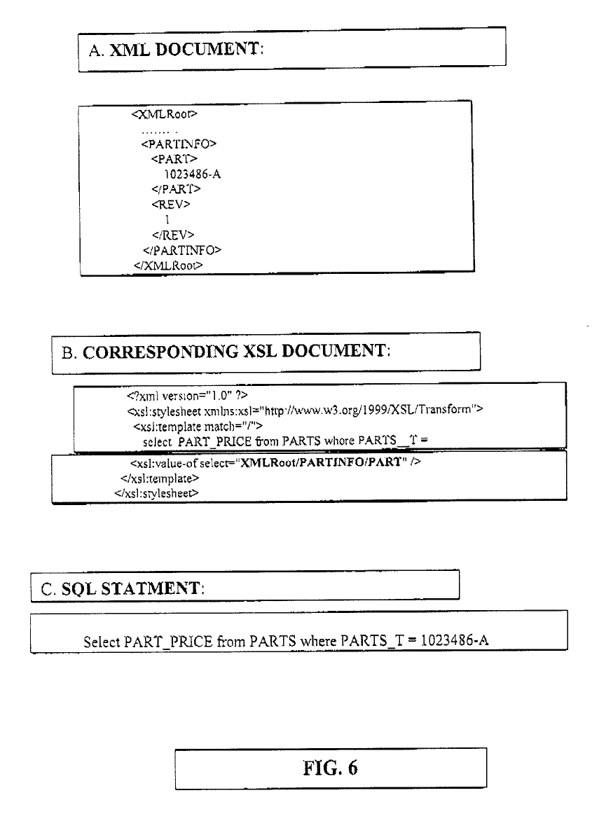

Reference is now made to FIGS. 6A-6C, which illustrate in a simplified manner how a combination of an XML file and a setup XSL file may result in an SQL query for use in accessing a database. FIG. 6A represents a section of an XML document that contains information about the user in a hierarchical form. The information may have been derived from any kind of user information that is available to the system. FIG. 6B shows an XSL document that is designed to extract specifically needed information from the XSL file 6A. The XSL file of FIG. 6B also contains the basic definition of an SQL statement that needs to be sent to a relational database, and thus serves as a setup file for the statement. FIG. 6C shows an SQL statement that is to be sent to query a relational database, and which is the result of using XSL file 6B and XML file 6A.

A more detailed explanation of the example that is shown in FIG. 6 is as follows: The SQL is defined within setup files, such as is shown in FIG. 6B or stored in the database in setup tables. Each identification procedure of this type preferably has an SQL template. The information that is used to parameterize the SQL comes from the user information that is stored in XML, and thus it is possible to use XSL constructs in order to combine the two. The SQL forms the underlying structure in which the XSL is used to extract information from the XML structure.

As an example, suppose that information about equipment that a user bought is gathered via data that the user has provided. Specifically the part number of the equipment is required. However, suppose that the distinguishing feature of the current communities is not the part number but rather the price category that the equipment belongs to. In this example there is a need to form a community for those customers who have purchased expensive equipment and a different community for those purchasing inexpensive equipment. For example, the difference between owners of Audi A4s and owners of Volkswagen Passats or the difference between owners of Mercury Sables and owners of Ford Tauruses. But we do not want or cannot ask the registering user about the equipment price. Also, prices tend to change and the information that is sought is not what price was paid rather the manufacturer's price—something the buyer is not really aware of. So, instead of capturing the price directly, the user is asked to provide the part number. Then pricing tables in databases are used to retrieve the part price. Based on this the user is categorized into the relevant community.

In order to capture the part number from the user, the user information structure in XML may take the form of FIG. 6A.

In order to make the necessary query the XSL shown in FIG. 6B is preferably provided as the identification procedure.

In this example pricing information is maintained in a PARTS table in a remote relational database. The XSL is processed by an XSL processor and is passed the user information (XML structure) as input. Whilst processing the XSL, the XML structure is used to extract the PART information and the value b 1023486-A is extracted. The result is that the XSL processor outputs the SQL statement shown in FIG. 6C.

The SQL statement shown in FIG. 6C is now used as a query body and the part price is extracted from the database. The part price value is then used as the criterion by which community membership is defined.

The third type of identification procedure is similar to the second kind—only instead of using a database to perform the query, the Internet or an Intranet is used to perform the query. In this case the process is similar to that described per database query. However, instead of the procedure generating a database query it generates an Internet query in the form of a Universal Resource Locator (URL), Universal resource Name (URN), or a Universal Resource Identifier (URI). Implementation using XML and XSL is similar. In this case the XSL produces a URL, URN, or URI, and these are used as the body for a Web or Internet query. An advantage of the identification procedure is that it opens up the entire Internet (so long as access is available) as a data store for information that may help the system in categorizing users in relation to communities.

The final type of identification procedure is more flexible in the sense that it can compute any value and be based on any algorithm. This fourth type of identification procedure is any procedure (function, or body of code) that takes user information as input and generates attributes that are then associated with the user. The advantage of this fourth type of identification procedure is that it is the most generic and can accomplish any identification. The disadvantage is that it involves writing code and in the context of this platform, customization and setup is best done using a small set of primitives (e.g. SQL and XSL) as opposed to writing code.

Registration Forms

Often, the way that user information is captured is through registration forms. A user wishing to be granted access to a site is asked first to fill out a registration form. This form is saved in a registration database and may later be used for targeted marketing initiatives, mailing lists, etc.

While registration forms are certainly not a new concept, the present embodiment provides registration forms which may be customized to a site's specific requirements while still providing a basis for capturing and managing user information. According to embodiments of the present invention the Internet platform is not a singular Web site but rather an infrastructure platform from which any Web site can be built. In this sense, every Web site—based on its area of interest—uses a different and specific structure and asks different questions of the users wishing to be granted access to the site and to join one or more of the communities being serviced by the site.

Preferably, a set of conventions is defined that site builders may adhere to when designing and implementing their registration forms. Specifically, registration forms that capture data about users should be able to associate this data with a name that is later used to index the data. A convention of data indexing is important since, without an agreed upon indexing method, it may be difficult to build generic identification procedures during setup. There is a linkage between the registration forms (that are flexible enough to suit an implementation of the present embodiments) and the identification procedures and computational procedures (that are also flexible enough to be specific to any given implementation).

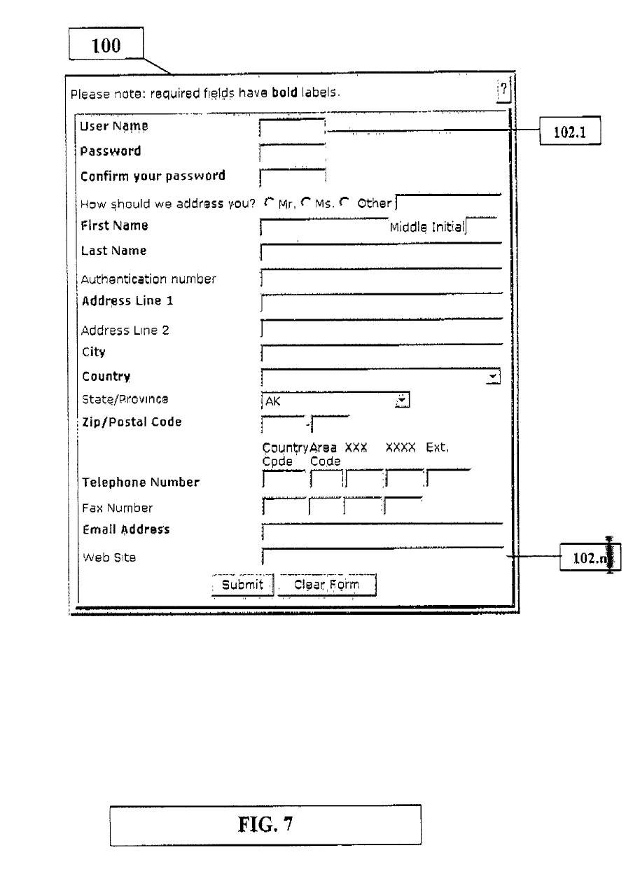

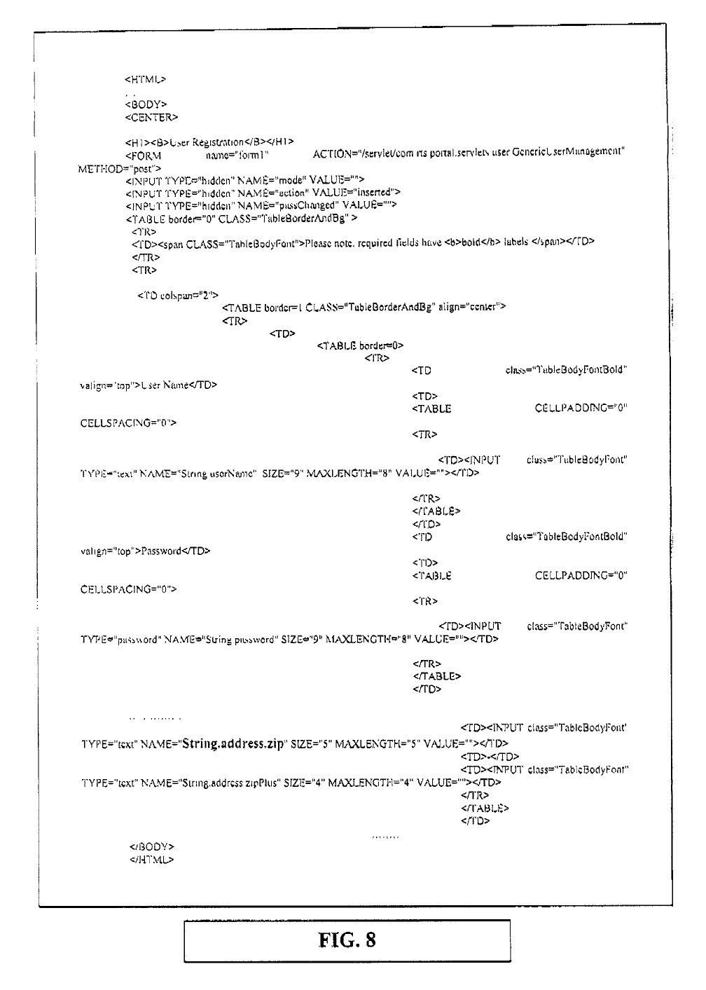

Reference is now made to FIGS. 7 and 8. FIG. 7 is a diagram showing a data entry form 100 having empty data fields 102.1-102.n, each labeled to indicate to the user the data that is desired in the particular field.

FIG. 8 shows some of the HTML corresponding to the form of FIG. 7, and shows how each data field 102.1-102.n is named in HTML according to the data indexing convention, for use in future data processing.

FIGS. 7 and 8 between them depict a simple example using the convention in which the user information is stored in XML. The process starts by building a registration form. The form may look like FIG. 7 and the HTML of the form may look like FIG. 8.

Much of the HTML source has been omitted for simplicity. Attention is drawn to the convention by which the input elements in the HTML are named. This is only one example of such a convention and any other convention is equivalent in the context of the process. Due to the convention in the example the data entered by the user can be transformed using the form into the XML user information in a very simple and systematic way. The convention in the example is that each name is composed of a set of tokens delimited by periods (see for example row 50 in FIG. 8). The first token specifies the data type of the element and the other tokens provide a path from which the hierarchical XML stricture is built. By processing the form an XML structure such as shown in FIG. 4A can easily be built. Therefore, any form can be constructed in a way that the information in it can be easily used to augment (or create) the user information. Once the user information has been augmented, the identification procedures make use of XPATH paths as already described.

Matching Rules

As discussed above, matching rules may be used for deciding which communities a user should belong to. When matching rules come into play each of the communities and each of the users has already been assigned a set of attributes. The rules preferably determine what groupings may be created based on the assigned sets of attributes.

Matching rules, as discussed above, are constructs that may obtain attributes of a community and of a user as input and return a boolean value. A returned value of TRUE preferably assigns the user to the present community group. Any implementation of a rule that adheres to this definition may be used as a matching rule for the purposes of the present embodiment. The implementation of matching rules in individual cases preferably depends on the way that the individual attributes concerned are represented. If for example the attributes are represented as name value pairs then matching rules can be as simple as comparing values using operators such as EQUAL, NOT_EQUAL, LARGER_THAN, SMALLER_THAN, or regular expressions that include wildcards. If attributes have a more elaborate structure then matching rules can include sets of containment operators, UNION, INTERSECTION, or other more computationally complete functions.

Computational Procedures and Fully Binding Elements

As explained above, when setting up the communities, elements preferably are associated with the community. These elements then form the substance of what it means to belong to a certain community—be it access to information or transactional applications. When a user is identified as belonging to a certain community those elements are added to the user's environment.

When the stage of adding elements to a matched user's environment is invoked, computational procedures come into play. If the elements defined for the community are fixed, they can immediately be added to the user's environment. However, as was noted, elements can be parametric. Parametric elements are preferably not added as is to a user's environment they must first be fully bound. The binding process is the process in which parameters are replaced with arguments.

Arguments, in the present context, are values that are computed based on available user information, as discussed above. The above-mentioned computational procedures are similar to the previously described identification procedures, and are preferably likewise divided into primitive and compound procedures. Primitive procedures may be computed directly from the user information, whereas compound procedures may require access to databases or other Web sites, and may alternatively or additionally require a custom algorithm that is applied to the user information. The computational procedures have a structure which is similar to the structure of identification procedures, and thus, for the sake of conciseness, will not be described in detail.

Computational procedures may take as input the user, the community, the user information, and the name of the parameter. The output from a computational procedure is a value. This value may be applied wherever an element uses the named parameter. Once all such values are applied, the element is fully bound and can be added to the user environment. If an element cannot be fully bound—for example there is no appropriate set of computational procedures—then the element is not added to the user environment.

For example, an element that displays the number of open service calls in a certain service center, is required to be added to the user environment of an employee of the service center. In this case we can define a business intelligence element that includes a query from a call center database. The query is parametric in the sense that instead of it being defined for a certain service center it has a parametric value by the name of {CENTER} (herein parameters are denoted by being placed within curly brackets but any other notation is equivalent). The element is then added to the community of all service center personnel.

When users register with the site they are preferably identified using their employee code to be an employee of a certain service center. At this point the system has sufficient information to identify which service center that user belongs to. A value denoting the respective service center is output from a computational procedure and is used to create a query that retrieves the respective number of service calls for the respective center. Thus, while all such employees belong to the same community and are provided with the same type of query, each one sees something that is specific to their own interest (and permissions).

The above-described feature is useful because without it there would typically be an explosion of communities (which are not intuitive in real life) because it would be necessary to build a community for every possible service center even though they do not differ in any significant way from what the community offers to the community members. The method described above of distinguishing between communities at the definition level and using this to control the environment created for the community members is thus a particularly preferred element in manageability of the community structures.

The present embodiments thus provide advantages over prior art dealing with communities on computerized platforms, wherein the notion of community support is not available in the generic sense (as opposed to sites being available for a specific community).

Some Specific advantages of embodiments of the present invention are:

1. Dynamic versus static. The categorization procedures in the above embodiments are based on sets of rules and parametric definitions. The identification procedures and the matching rules allow for continuous evaluation, for example when user profiles change. These can affect the membership in the various communities, Therefore, communities are not static but rather reflect the true set of communities to which users belong to at any point in time.

2. Automation and Support for Large Number of Users: Although site administrators can manually associate users with certain groups, the preferred embodiments provide full automation of the process, as described above. Once the identification procedures and matching rules are defined and elements are assigned to the groups, the process of providing access and features through the elements to users is done automatically. This is useful in any Internet community-enabling solution. Internet sites and Internet applications must support large numbers of users—numbers that can grow to tens and hundreds of thousands and even millions. Supporting such large numbers of users precludes the use of any manual process. The solutions of the above embodiments support full automation without necessarily sacrificing available features. Community management is simplified since it is now preferably decoupled from the actual number of users in the community. The community is managed at a definition level per the community groups as opposed to a user level. The creation and update processes are responsible for propagating necessary changes to all members of the community.

3. Enabling different status and access levels within a single community: Building a community preferably involves three things—defining the criteria by which someone belongs to the community, defining the elements that are available to community members, and defining the way that arguments are computed per community member and are then used in order to fully bind an element. Elements may be anything that the Internet can provide access to (and thus anything that can, be produced digitally). Parameterization allows for the possibility that even within a certain community there are different status and access levels. Parameterization allows for communities to have subgroups and thus reduces the overall number of communities needed to serve given sets of users. Without the possibility of parameterization, there is a risk of an explosion in group/community numbers to the extreme point that each user might need to be defined as its own group for every one of the users interests.

4. The use of parameters enables community elements to be defined at a generic level and yet deliver focused capabilities as are required for supporting the community based on the user's needs. The notion of a parametric community as an entity that can then be used to form a plurality of virtual sub-communities facilitates simple definition and management.

5. The process of assigning users to communities involves defining identification procedures, defining matching rules that define associations between users and communities, and defining computation of values that are used as arguments to fully bind parametric entities. The above definitions are easy to build since they are preferably phrased intuitively in the same way that a person would define “what it means to belong to such-and-such community”. Furthermore, the implementation of the identification procedures is based on a set of standard languages (with the advantage that there is no proprietary learning involved) that together can access practically any data repository. This means that the rules are not only easy to build and computationally complete, but they are also very powerful in marrying any data that can be accessed on Intranets, Extranets, and the Internet. Such a combination of standard languages in order to implement computational procedures and data access is useful.

6. Flexibility and Extensibility: The fact that elements are defined per community and yet the attributes and profiles that are used to compute group ownership are attached to users permits extensibility. When associations are directly maintained between groups and users, adding new groups or changing the meaning of the community groups is something very difficult or impossible to do (especially when there is a large number of users as is typical on the Internet). In such a scheme the initial set of groups is almost completely static and changing the community structure is not something easily contemplated since it would involve rebuilding all associations and manual intervention for each user in any affected community. By contrast, in embodiments of the present invention, the fact that all community association and all elements are based on identification procedures, matching rules, and computed values means that community definitions may change without requiring manual processes and without limitations that are a result of the old definitions of the community groups. This may occur simply by changing the definitions of the communities.

There is thus provided a system and method for allowing user data, whether from forms filled by the user himself, or from databases or other sources directly available or available via a network, to assign users to communities and sub-communities. In a preferred embodiment, the system makes use of hierarchically arranged data and various possibilities for hierarchically arranged data are discussed, in particularly hierarchically arranged data strategies that are comparable with the widely used Internet format HTML.

It is appreciated that certain features of the invention, which are for clarity described in the context of separate embodiments, may also be provided in combination in a single embodiment. Conversely various features of the invention which are, for brevity, described in the context of a single embodiment may also be provided separately on in any suitable sub combination.

It will be appreciated by persons skilled in the art that the present invention is not limited to what has been particularly shown and described hereinabove. Rather the scope of the present invention is defined by the appended claims and includes both combinations and subcombinations of the various features described hereinabove as well as variations and modifications thereof, which would occur to persons skilled in the art upon reading the foregoing description.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each user publication, patent or patent application was specifically and individually indicated to be incorporated herein by reference. In addition, citation or identification of any reference in this application shall not be construed as an admission that such reference is available as prior art to the present invention.

What is claimed is:

1. A system for defining communities and matching users into said communities, said matched users thereby gaining access to one or more elements associated with said communities; the system comprising a host connected to a network being for communication with a plurality of users, said system being configured for:
(i) creating at least one community by defining attributes for each of said communities; and
(ii) defining one or more elements associated with each of said communities; and
(iii) assigning attributes to a user on the basis of data extracted from information associated with the user; and
(iv) matching said attributes of at least one user to attributes of at least one community; assigning said user to said community based on the result of said matching: said user thereby gaining access to at least one element associated with said community.

2. The system of claim 1 wherein said information associated with the user is received from input from at least one of a group comprising the user itself, at least one remote database, at least one local database, at least one local system, at least one remote system, at least one web site, at least one custom-built algorithm, and any combination thereof.

3. The system of claim 1 wherein said community attributes are inferred based on data available to said host.

4. The system of claim 1 wherein said community attributes are inferred based on data that is associated with users.

5. The system of claim 1 wherein the host is configured to rematch the attributes of users to attributes of communities automatically whenever there is an occurrence of any one of a group of conditions comprising a change in at least one attribute of at least one community, an update of at least one value of an attribute of at least one community, a change in at least one attribute of a user, an update of at least one value of an attribute of a user or any combination thereof.

6. The system of claim 1 configured such that said elements are associated with a community at a set up time of said community.

7. The system of claim 1 wherein the access of said user to at least one element is according to a permission level being assigned to the community.

8. The system of claim 1 wherein said access of said user to a subset of elements is according to a permission level being assigned to the user.

9. The system of claim 7, wherein said permission level is determinable at setup time of at least one community, for at least one user according to anticipated user attributes.

10. The system of claim 8 wherein said permission level is determinable at setup time of at least one community, for at least one user according to anticipated user attributes.

11. The system of claim 1 wherein at least one element is automatically customizable for said user based on one or more of said user's attributes.

12. The system of claim 6 wherein at least one element is automatically customizable once per community, at set up time according to foreseeable user attributes.

13. The system of claim 1 wherein at least one element that is associated with at least one community is parametric; said parametric element able to receive a value that is specific to a user matched to at least one community, as an argument; said value being derived from any one of a group comprising a computation, an algorithm, a simple value of a user attribute, a simple mathematical value and any combination thereof that are based on any information available to said host.

17. A method of producing compatible forms comprising tagged fields, the method comprising the steps of:
(a) setting up a hierarchy of labels as nodes on a tree such that each node is specifiable by a descending order of labels,
(ii) tagging fields with labels of an appropriate one of said nodes for a meaning of the field if an appropriate node exists,
(iii) adding a new label as a node to said tree if an appropriate node does not exist, and
(iv) tagging a field with a label of said new node.
such that a second form using fields labeled by the concatenation of the labels marking the nodes of the tree formed from the first form is compatible with said first form.

18. The method of claim 17 wherein said first form is in any one of a group comprising extensible markup language format (XML) and derivatives thereof.

19. The method of claim 17 wherein said second form is any one of a group comprising HTML format and extensions of HTML format.

20. A method for use on a system comprising a host and a network, having at least one community defined by at least one attribute and having at least one element; the method comprising selecting at least one attribute of a community, said attribute being parametric and receiving the value of an attribute belonging to a user already matched to said community.

21. The method of claim 18 wherein said value defines the access gained by the user to at least one element.

22. A method of dynamically matching a plurality of users to at least one user group, at a host connected via a network to said users, comprising the steps of:
(i) predefining at least one user group in terms of a value of at least one attribute;
(ii) assigning at least one attribute to at least one user;
(iii) obtaining a value for said user attribute;
(iv) matching said user attribute value to said group attribute value, and
(v) assigning said user to said group based on a result of said matching.

23. The method of claim 20 wherein assignment to said group gives said user access to at least one element associated with said group.

24. The method of claim 20 wherein said group is a subset of a community.
